(19) United States
(12) Patent Application Publication
(10) Pub. No.: US 2008/0278930 A1
(43) Pub. Date: Nov. 13, 2008

(54) Tool structure with illumination

(75) Inventors: Ching-Huei Wu, San Chung City (TW); Ching-Mo Wu, San Chung City (TW); Nien-Lu Fang, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto technology Co., Ltd.

(21) Appl. No.: 11/798,044

(22) Filed: May 9, 2007

(51) Int. Cl. B25B 23/18

(52) U.S. Cl. 362/120

(57) ABSTRACT

A tool structure with illumination comprises a base, a tool body and at least one light-emitting device. The base has a slot for holding therein a circuit board. The circuit board has two electrical pins extending outside of the base. The tool body has a plurality of insertion holes on the front end for insertion thereinto of the electrical pins of the circuit board. The tool body is designed for holding therein at least one battery so as to allow electrical connection between the electrical pins of the circuit board and the battery. The at least one light-emitting device is mounted on the circuit board of the base and electrically connected thereto for providing illumination.

### FIELD OF THE INVENTION

The present invention relates to a hand tool structure or the like, and more particularly to a tool structure with illumination that integrates a base, a tool body and at least one light-emitting device for illuminating the operation site.

### BACKGROUND OF THE INVENTION

General publics always take into consideration the rigidness and durability of the hand tool such as screwdriver. In addition, the general publics also take into consideration the feel for holding the screwdriver because good tools are prerequisite to the successful execution of a job.

It is very inconvenient when the operation position is short of sufficient intensity of illumination. Therefore, an auxiliary lighting device for coupling with a hand tool has been disclosed to facilitate the operation. For example, the published Taiwan Patent No. M277,860 has disclosed an auxiliary lighting device for hand tools, which comprises a clip assembly to clip and position the auxiliary lighting device on a predetermined hand tool for providing auxiliary illumination.

However, the auxiliary lighting device described above is clipped to the hand tool by the clip assembly. The clip assembly may hinder the operation of the hand tool and is confined to only several hand tools. In view of this, the present inventor makes diligent studies in providing the general public with a tool structure with illumination, which has simplified structure, replaceable light-emitting device and low production cost.

### SUMMARY OF THE INVENTION

It is an object of the present invention to provide a tool structure with illumination that integrates a base, a tool body and at least one light-emitting device, wherein a circuit board and the at least one light-emitting device are mounted inside a slot of the base and the base is sleeved onto the front end of the tool body so that the operation site is free from shadow when the user applies the tool body to the operation site. Accordingly, the operation site can be provided with sufficient intensity of illumination without the need to use an auxiliary lighting device, thereby increasing overall practicability and convenience.

It is another object of the present invention to provide a tool structure with illumination, wherein a base that has a light-emitting device is mounted on the front end of the tool body so that the tool structure is still usable by replacing the base when the light-emitting device of the base is damaged, thereby increasing overall practicability and convenience.

In order to achieve the foregoing objects, a tool structure with illumination is comprised of a base, a tool body and at least one light-emitting device. The base has a slot for holding therein a circuit board. The circuit board has two electrical pins extending outside of the base. The tool body has a plurality of insertion holes on the front end for insertion thereinto of the electrical pins of the circuit board. The tool body is designed for holding therein at least one battery so as to allow electrical connection between the electrical pins of the circuit board and the battery. The at least one light-emitting device is mounted on the circuit board of the base and electrically connected thereto for providing illumination.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a preferred embodiment of the present invention.

FIG. 2 is an elevational, decomposed view showing the preferred embodiment of the present invention.

FIG. 3 is a schematic, cross-sectional view showing the assembled structure of the preferred embodiment of the present invention.

FIG. 4 is a schematic view showing the utilization status of the preferred embodiment of the present invention.

### DETAILED DESCRIPTION OF THE PREFERRED EMBODIMENT

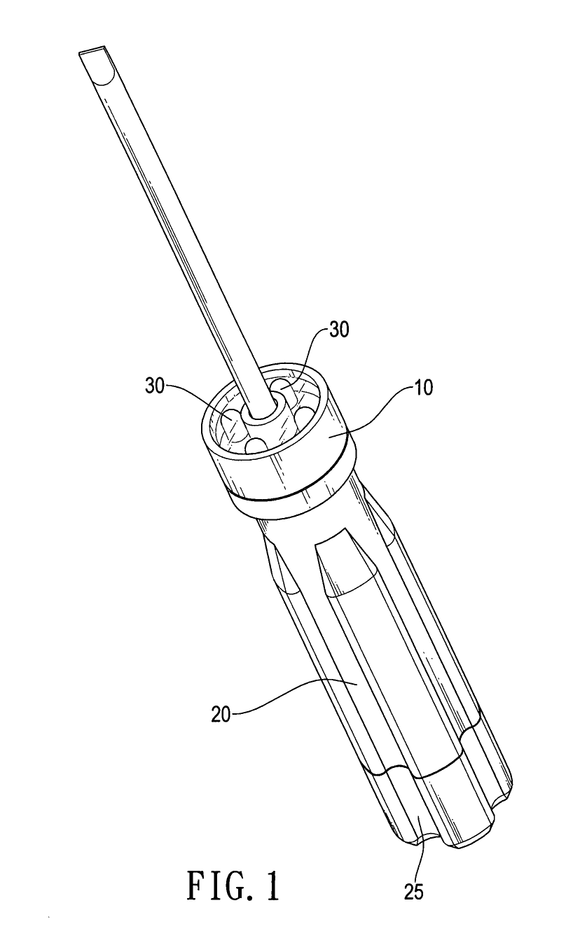

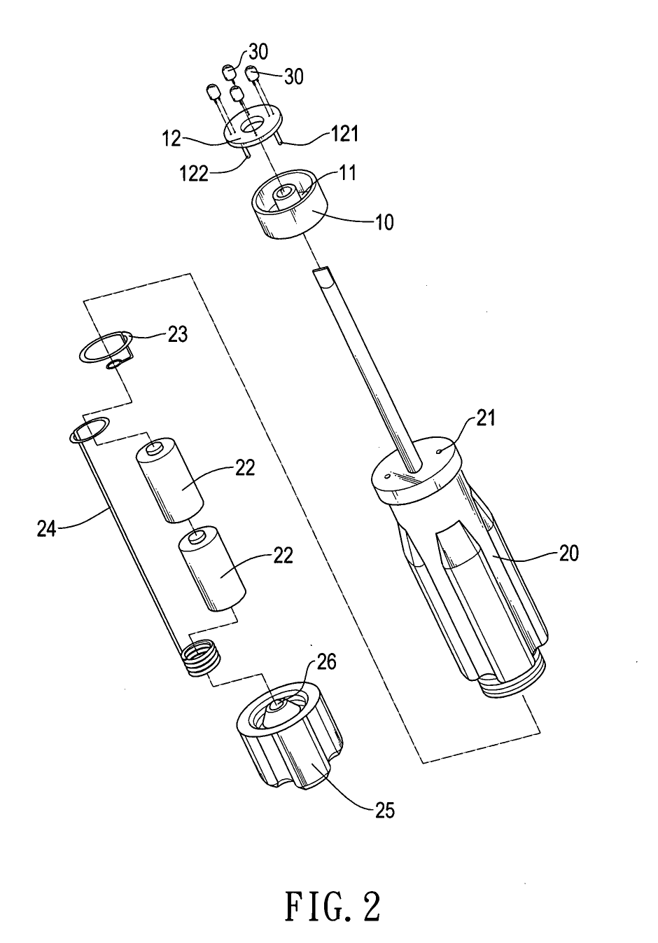

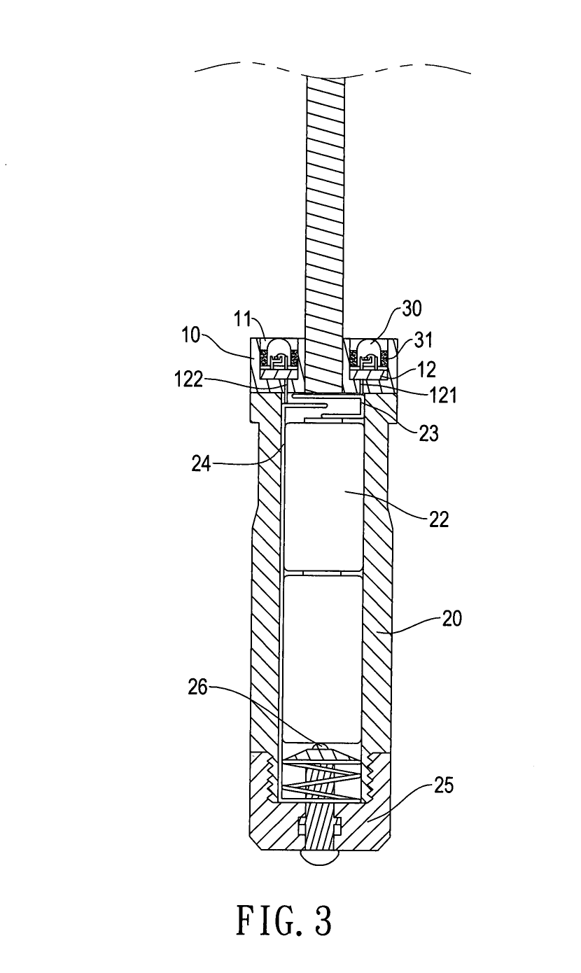

Referring to FIGS. 1 through 3, an improved tool structure with illumination of the present invention comprises a base 10, a tool body 20 and at least one light-emitting device 30. A slot 11 is formed inside the base 10 for supporting a circuit board 12. The light-emitting device 30 is mounted on the circuit board 12. In this preferred embodiment, the light-emitting device 30 is a light-emitting diode (LED). The inside of the slot 11 of the base 10 is covered with an adhesive layer 31 for covering the light-emitting diode. The adhesive layer 31 is made of a light-pervious material such as resin, silicone, etc. An anode pin 121 and a cathode pin 122 are mounted on the circuit board 12, and extended outside of the base 10. In addition, a plurality of insertion holes 21 are formed on the front end of the tool body 20 for insertion thereinto of the anode pin 121 and the cathode pin 122 of the circuit board 12. At least one battery 20 is designed to be held in the tool body 20. In addition, an anode-conducting device 23 and a cathode-conducting device 24 are further mounted on the inside of the tool body 20 so that the anode pin 121 of the circuit board 12 can be electrically connected to an anode of the battery 22 via the anode-conducting device 23. In addition, the rear end of the tool body 20 is covered with a rear cover 25 on which a cathode-conducting bump 26 is mounted, wherein the cathode-conducting bump 26 is connected to a cathode of the battery 22. In addition, the cathode-conducting device 24 is placed to sleeve the cathode-conducting bump 26 for electrically connecting the cathode of the battery 22 with the cathode pin 122 of the circuit board 12. In such a structure, the battery 22 is electrically connected to the circuit board 12 for electrifying the at least one light-emitting device 30, thereby forming the improved tool structure with illumination.

Referring to FIGS. 1 through 3, the present invention is featured in that the circuit board 12 and the at least one light-emitting device 30 are mounted on the inside of the slot 11 of the base 10 so that the base 10 is sleeved onto the front end of the tool body 20. In the improved tool structure with illumination, the light beams can be emitted from the light-emitting device 30 to illuminate the operation site straightly. In addition, the light beams emitted laterally from the light-emitting device 30 can also provide sufficient intensity of illumination to free the operation site from the shadow without the use of auxiliary lighting device. Besides, the base 10 that has mounted thereon the light-emitting device 30 is mounted on the front end of the tool body 10 so that the tool structure is still usable by replacing the base 10 when the light-emitting device 30 of the base 10 is damaged.

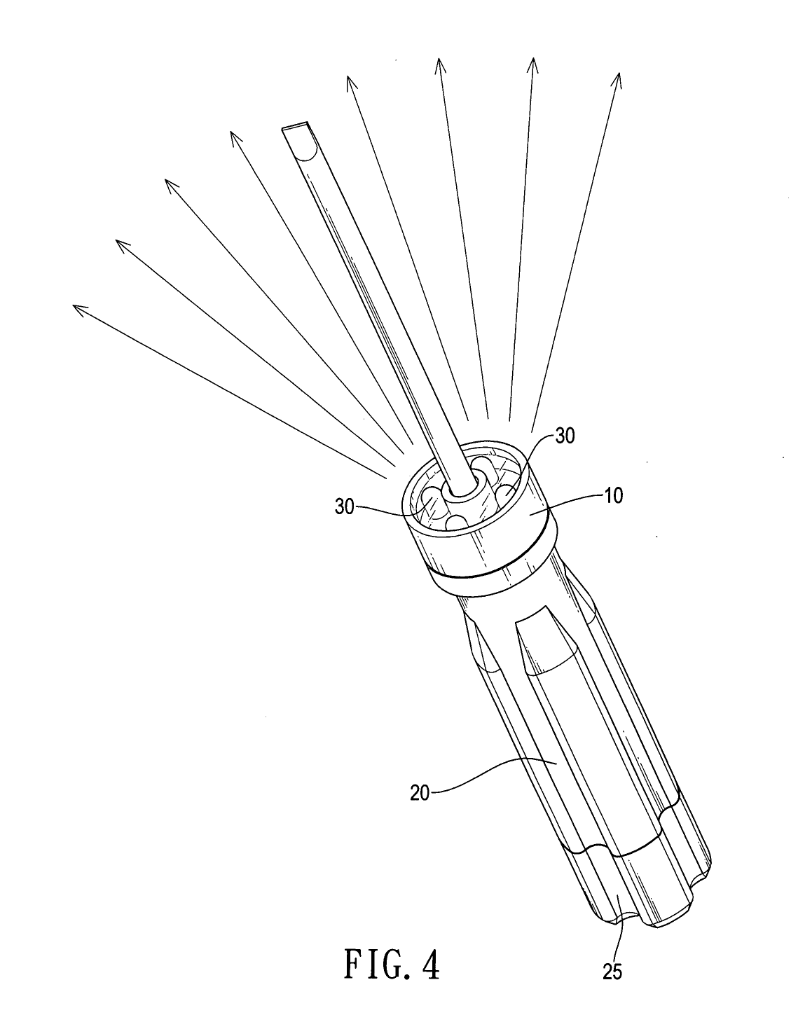

Referring further to FIG. 4, the utilization status of the tool structure with illumination of the present invention is shown. In this preferred embodiment, the tool structure is a screwdriver, but not limited thereto. The tool body 20 has the base 10 on the front end, wherein several light-emitting devices 30 are mounted around the inside of the slot 11 of the base 10. The rear cover 25 is mounted on the rear end of the tool body 20 for controlling the lighting status of the light-emitting devices 30 mounted inside the base 10 so as to enable or disenable the light-emitting devices 30 to provide the illumination. As a result, the operation site is provided with sufficient intensity of illumination and free from shadow when the user applies the tool body 20 to the operation site.

To sum up, the present invention is capable of achieving the aforementioned objects. The present invention discloses a tool structure with illumination, which has simplified structure, replaceable light-emitting device and low production cost. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A tool structure with illumination, comprising:
a base having a slot on the inside for supporting therein a circuit board on which two electrical pins are mounted to extend outside of said base;
a tool body having a plurality of insertion holes on a front end for insertion thereinto of said electrical pins of said circuit board and being designed for holding therein at least one battery so as to allow electrical connection between said electrical pins of said circuit board and said battery; and
at least one light-emitting device mounted on said circuit board of said base to electrically connect with said circuit board for providing illumination.

2. A tool structure with illumination according to claim 1, further comprising an adhesive layer mounted inside said slot of said base for covering said at least one light-emitting device.

3. A tool structure with illumination according to claim 2, wherein said adhesive layer is made of resin.

4. A tool structure with illumination according to claim 2, wherein said adhesive layer is made of silicone.

5. A tool structure with illumination according to claim 1, wherein said tool body is a screwdriver.

6. A tool structure with illumination according to claim 1, wherein said at least one light-emitting device is at least one light-emitting diode.
